(19) United States
(12) Patent Application Publication
(10) Pub. No.: US 2007/0141892 A1
(43) Pub. Date: Jun. 21, 2007

(54) Cable manager for modular jacks

(75) Inventor: James John Gula, Harrisburg, PA (US)

Correspondence Address: Tyco Technology Resources, Suite 140, 4550 New Linden Road, Wilmington, DE, 19808-2952, US

(73) Assignee: Tyco Electronics Corporation

(21) Appl. No.: 11/314,635

(22) Filed: Dec. 21, 2005

(51) Int. Cl. H01R 4/24

(52) U.S. Cl. 439/392

(57) ABSTRACT

A cable manager for termination of a cable with a modular jack is provided. The cable manager includes a housing defining a jack receptacle configured and dimensioned to receive legs extending from the modular jack, the housing including a bottom wall defining a recess formed in a front edge thereof for receiving a cable therein; and a cable clamp reciprocally supported on the housing for securing a cable within the recess of the housing. The cable clamp is movable from a first position in which the cable is positionable within the recess of the bottom wall of the housing and a second position in which the cable is not insertable or removable from the recess of the bottom wall of the housing. Accordingly, the twist of the wires is maintained up to the point of termination.

### BACKGROUND

1. Technical Field

The present disclosure relates generally to cable managers for lacing and terminating cables and, more particularly, to cable managers for use in lacing and terminating modular jacks and the like.

2. Background of Related Art

Cabling, such as unshielded twisted pair, shielded twisted pair, coaxial and fiber optic cabling, is being increasingly used in the telecommunications industry to provide data, voice, video or audio information. Proper termination of cabling is important in order to ensure optimal data transmission and to reduce cross-talk and the like.

Modular jacks are receptacles that accept a plug and the like, and are frequently used to electrically interconnect telecommunication equipment. There are several standards that dictate how the modular jacks are constructed and perform including, and not limited to, TIA/EIA 568 B standard and FCC part 68 standard. An example of a modular jack is the SL Series Connector, available from Tyco Electronics Corporation, Middletown, Pa., or the eXtreme 6+ Connector, available from Leviton®, Bothell, Wash.

At present, modular jacks are terminated by lacing individual wires into the connector and using an impact or non-impact tool, specifically designed for the connector, to seat the wires into the connector.

Moreover, various cable managers require different tools or the like for terminating a cable. Additionally, each cable manager is typically held, by hand, in position relative to the termination tool. Accordingly, the need exists for cable managers or the like which are configured and adapted for selective fixable positioning on the termination tool to enable more consistent and uniform termination.

Accordingly, a need also exists for cable managers configured and adapted for more efficient termination of modular jacks and the like.

A need exists for cable managers including means for terminating modular jacks with a single stroke of a tool, such as, for example, the SL Series Connector Jack Tool Assembly, available from Tyco Electronics Corporation, Middletown, Pa. Reference may be made to U.S. application Ser. No. 10/454,709, filed Jun. 4, 2003, entitled “Cable Terminating Apparatus and Method”, the entire content of which is incorporated herein by reference, for a detailed discussion of an exemplary connector tool jack assembly. Desirably, the connector tool jack assembly is capable of accommodating a variety of cable managers including, and not limited to, the cable manager according to the present disclosure.

### SUMMARY

Cable managers for use in lacing and terminating modular jacks and the like are provided.

According to an aspect of the present disclosure, a cable manager, for terminating a cable including a plurality of wires, to a modular jack having a plurality of legs extending from a body thereof, is provided. The cable manager includes a housing configured and dimensioned to selectively receive the legs of the modular jack; and a cable clamp reciprocally supported by the housing for securing the cable to the housing during at least one of a lacing and terminating procedure. Accordingly, the twist of the wires is maintained up to the point of termination.

According to another aspect of the present disclosure, an improved cable manager for use with a tool for terminating the wires of a cable to a modular jack is provided. The modular jack includes legs extending from a body which supports a plurality of resilient contact tines in parallel arrangement within an interior receptacle thereof, and the tool includes at least one leg for supporting the cable manager and the modular jack and which is configured and adapted to join the cable manager to the modular jack to terminate the cable. The cable manager includes a housing configured and dimensioned to selectively receive the legs of the modular jack; and a cable clamp reciprocally supported by the housing for securing the cable to the housing during a lacing and/or terminating procedure. Accordingly, the twist of the wires is maintained up to the point of termination.

In an embodiment, the housing may include a top wall, a bottom wall, and side walls; and a receptacle defined by the top, bottom and side walls, wherein the receptacle is configured and dimensioned to receive the stems of the modular jack therein, and wherein the receptacle includes a first receptacle portion, a second receptacle portion and a third receptacle portion. The housing may further include a pair of dividing walls separating the first, second and third receptacle portions; a plurality of slots formed in a front edge of each of the side walls and the pair of dividing walls; wherein respective slots of the side walls and the pair of dividing walls are aligned with one another; and cut-off blades positioned in each of the first and third receptacle portions for severing wires extending thereacross during a termination procedure.

The bottom wall of the housing may define a recess formed in a front edge thereof, wherein the recess is substantially aligned with the second receptacle portion.

The housing may include an outer bottom wall spaced a distance from the bottom wall and defining a channel therebetween. Accordingly, the cable clamp may be slidably supported within the channel. The outer bottom wall may include a recess formed in a front edge thereof, wherein the recess of the outer bottom wall is substantially aligned with the recess of the bottom wall of the housing.

The cable clamp may include a hook portion for engaging a cable placed within the recesses of the bottom wall and the outer bottom wall of the housing. The cable clamp desirably has a first position in which the hook portion thereof is in registration with the recesses of the bottom wall and the outer bottom wall of the housing, for securing the cable in position relative to the housing, and a second position in which the hook portion thereof is out of registration with the recesses of the bottom wall and the outer bottom wall of the housing, allowing for the cable to be positioned in said recesses of the housing. The cable clamp may be biased to the first position.

The cable clamp may include a tail having a tab extending therefrom. The tab may be configured and adapted to selectively engage a recess provided on a termination tool.

According to yet another aspect of the present disclosure, a cable manager for termination of a cable with a modular jack is provided. The cable manager includes a housing defining a jack receptacle configured and dimensioned to receive legs extending from the modular jack, the housing including a bottom wall defining a recess formed in a front edge thereof for receiving a cable therein; and a cable clamp reciprocally supported on the housing for securing a cable within the recess of the housing. The cable clamp is movable from a first position in which the cable is positionable within the recess of the bottom wall of the housing and a second position in which the cable is not insertable or removable from the recess of the bottom wall of the housing. Accordingly, the twist of the wires is maintained up to the point of termination.

The cable clamp may include a tab extending from a surface thereof for selective engagement with a recess formed in a surface of a terminating tool. Desirably the terminating tool is configured and adapted to join the cable manager and the modular jack. The cable clamp may include a hook portion configured and adapted to at least partially occlude the recess of the bottom wall of the housing when the clamp member is in the second position and to not occlude the recess of the bottom wall of the housing when the clamp member is in the first position.

For a better understanding of the present invention and to show how it may be carried into effect, reference will now be made by way of example to the accompanying drawings.

### DETAILED DESCRIPTION OF THE DRAWINGS

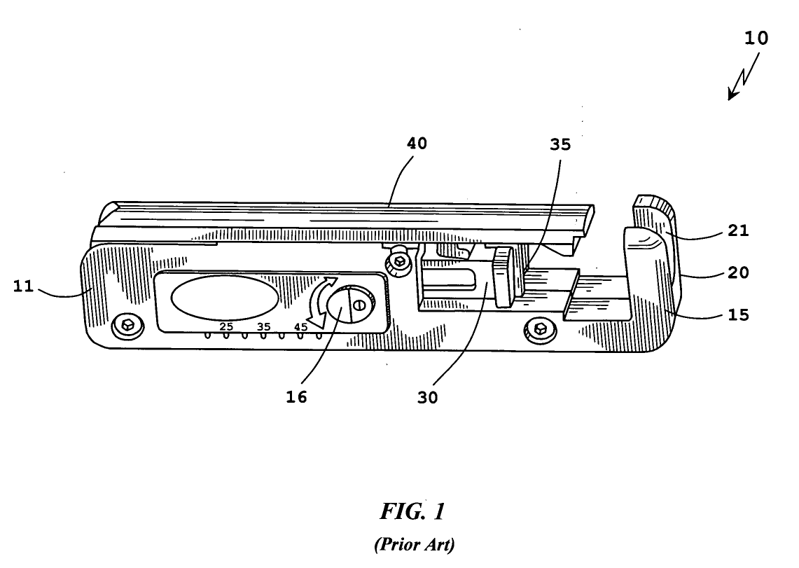

FIG. 1 is a perspective view of a prior art cable terminating tool;

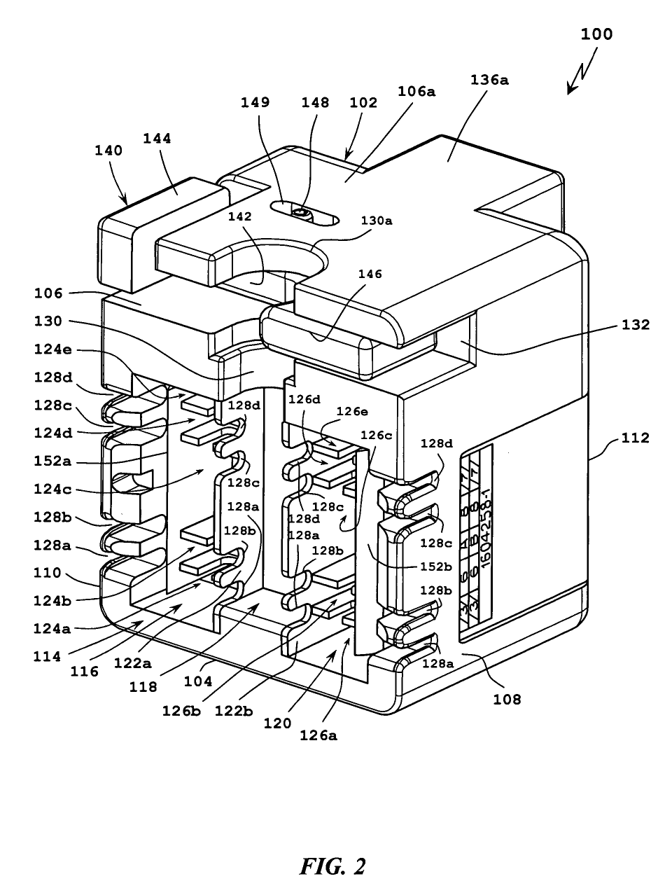

FIG. 2 is a perspective bottom view of a cable manager according to an embodiment of the present disclosure;

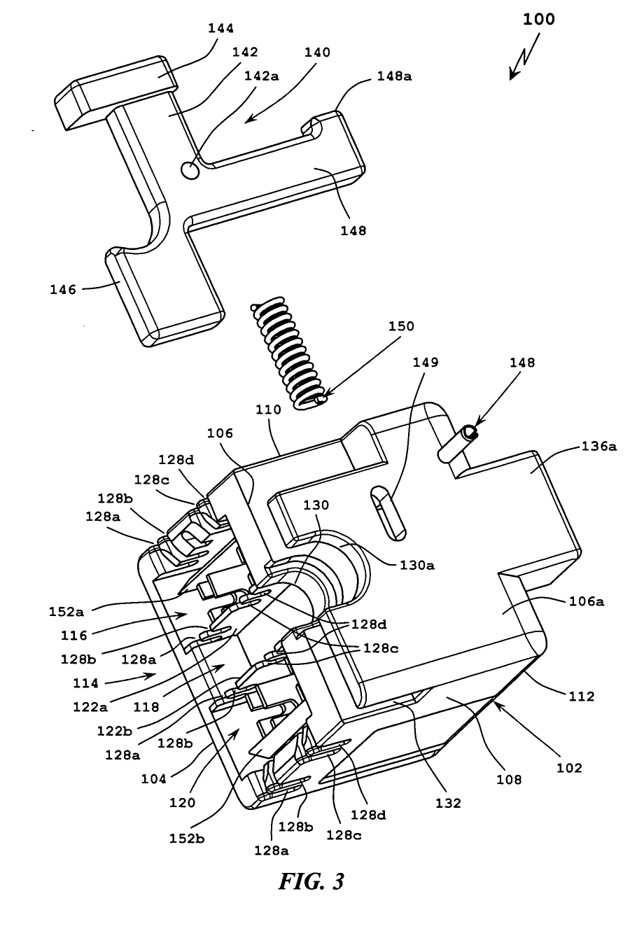

FIG. 3 is an exploded perspective view of the cable manager of FIG. 2;

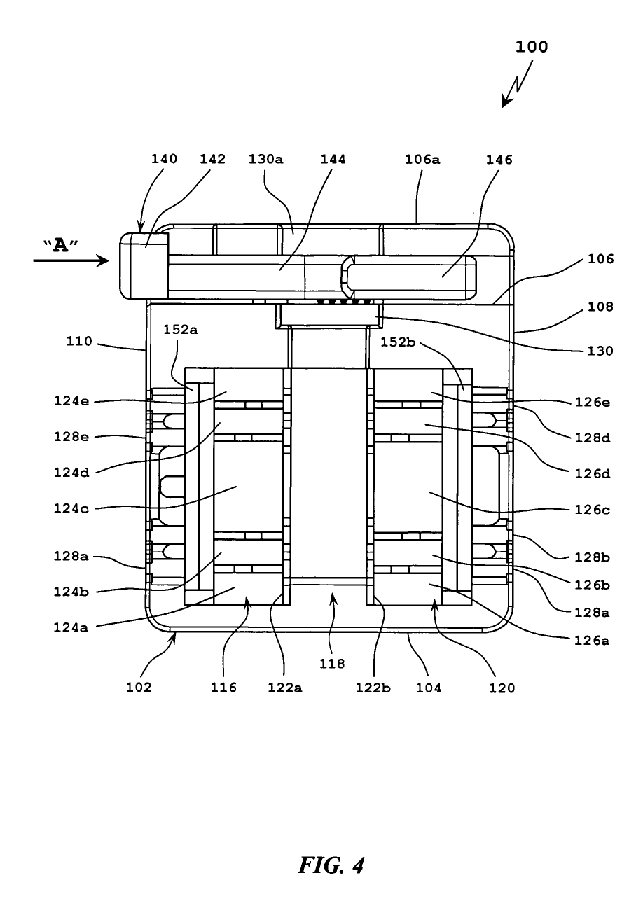

FIG. 4 is a front elevational view of the cable manager of FIGS. 2 and 3;

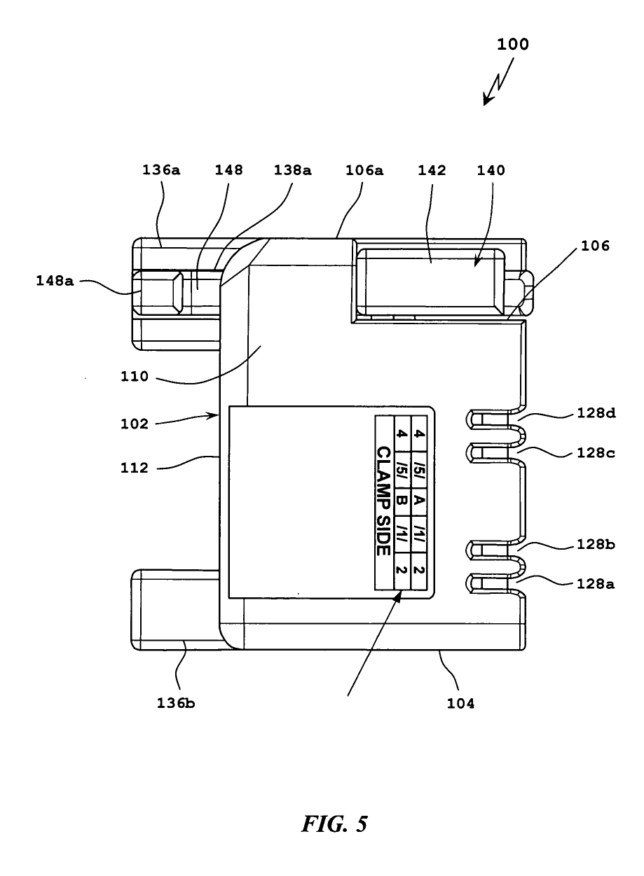

FIG. 5 is a right side elevational view of the cable manager of FIGS. 2-4;

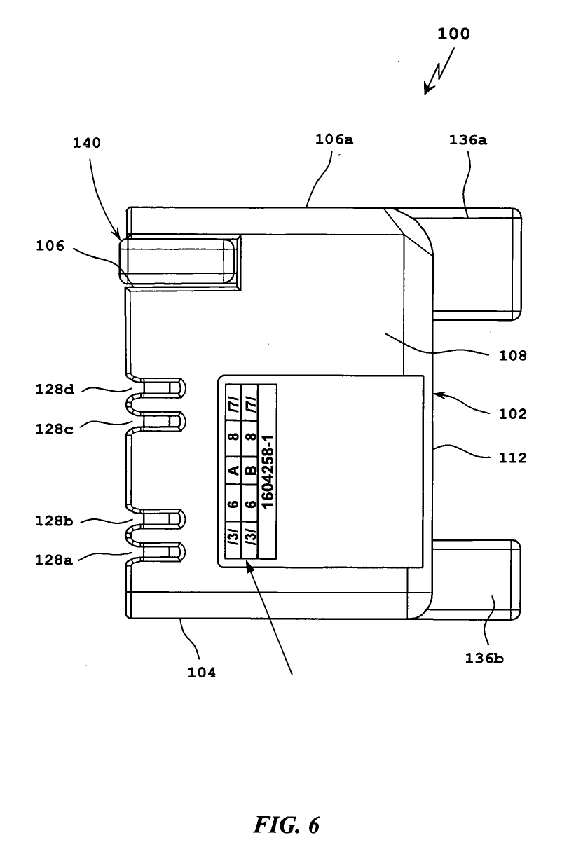

FIG. 6 is a left side elevational view of the cable manager of FIGS. 2-5;

FIG. 7 is a perspective view of a prior art category 6-type modular jack for use with the tool of FIG. 1 and the cable manager of FIGS. 2-6;

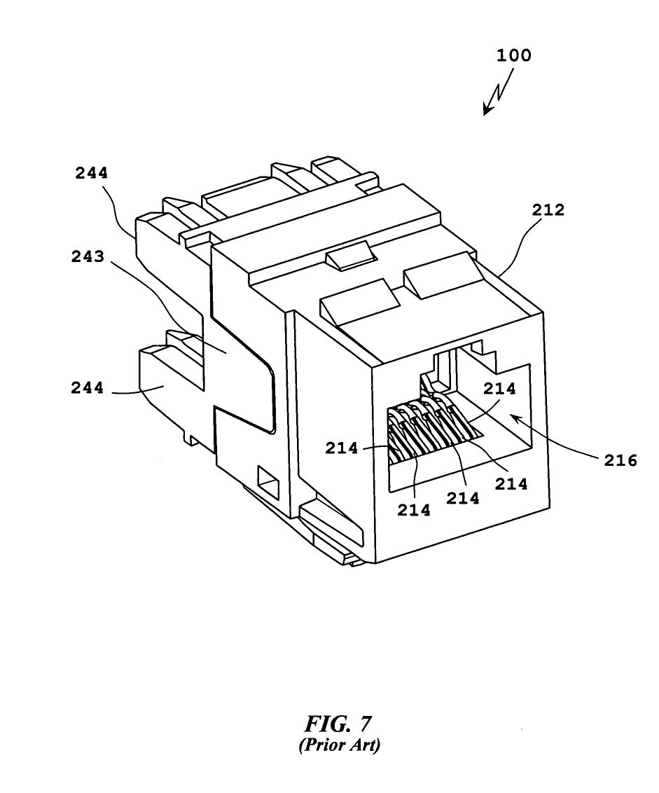

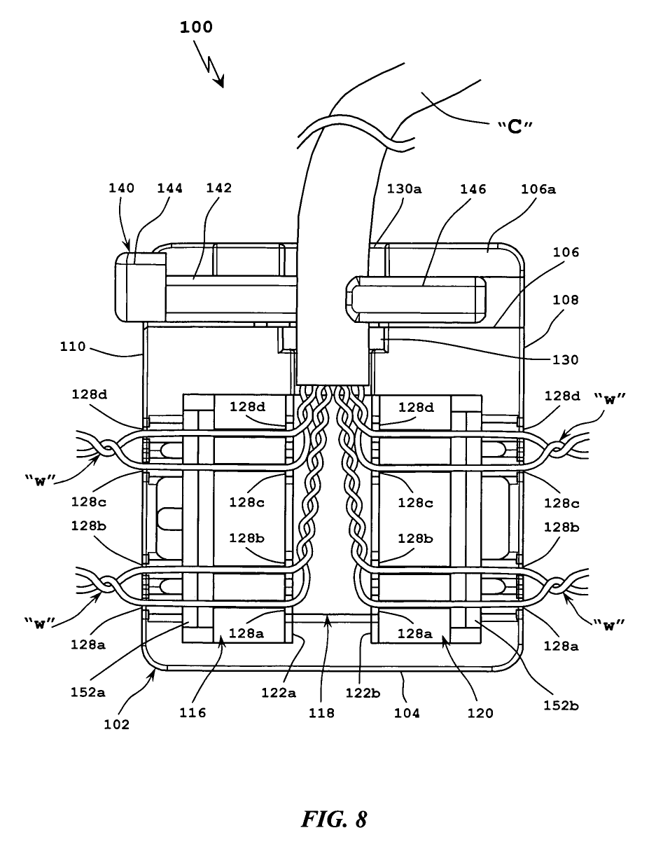

FIG. 8 is a front elevational view of the cable manager of FIGS. 2-6 illustrating the lacing and/or positioning of a cable and wires thereto;

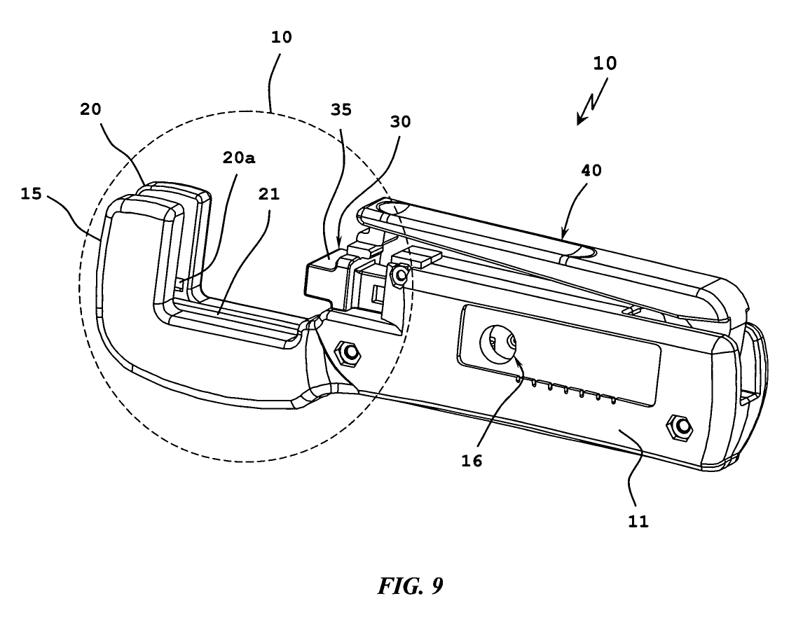

FIG. 9 is a perspective view of a cable terminating tool configured and adapted for cooperative use with the cable manager of FIGS. 2-8;

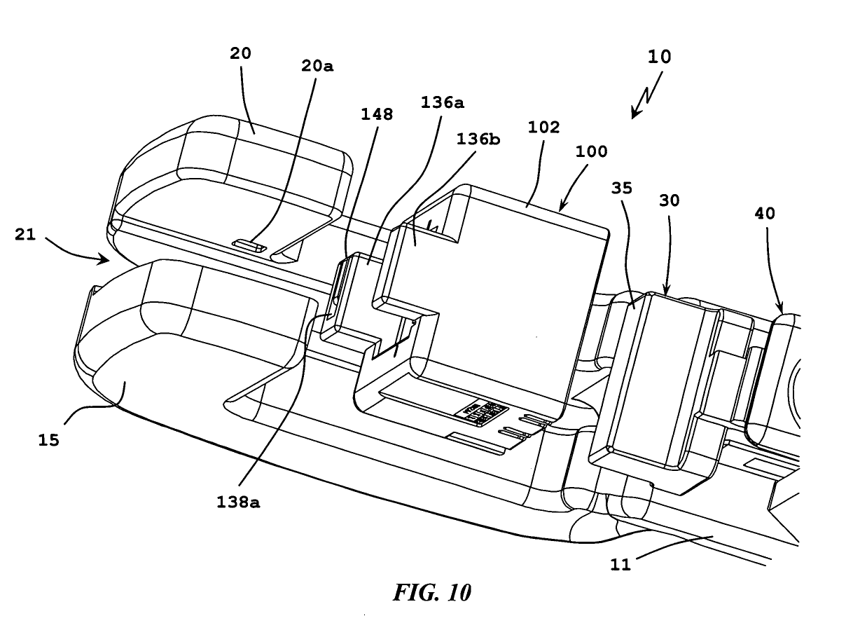

FIG. 10 is a perspective view illustrating the insertion of the cable manager of FIG. 2 in a prearranged position in the tool of FIG. 9;

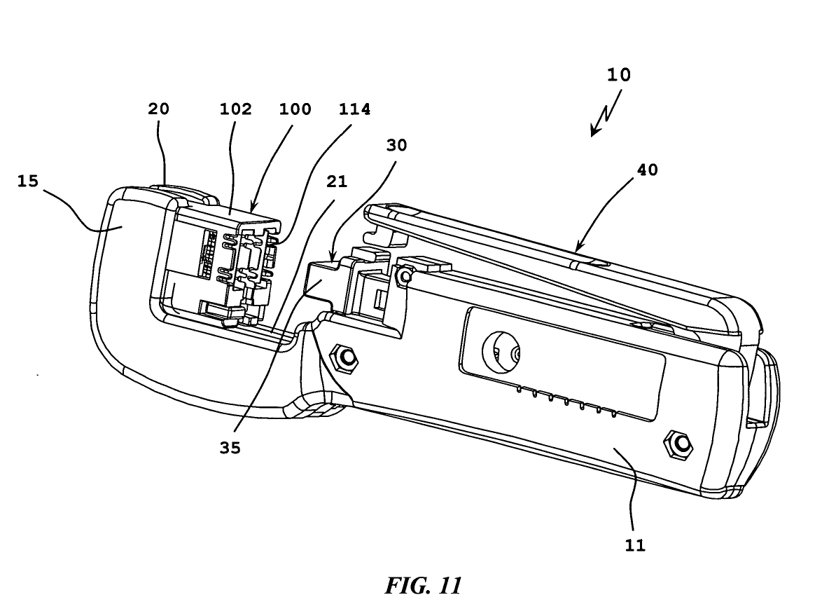

FIG. 11 is a perspective view of the tool of FIG. 9, illustrating the cable manager of FIGS. 2-6 fully engaged therewith; and

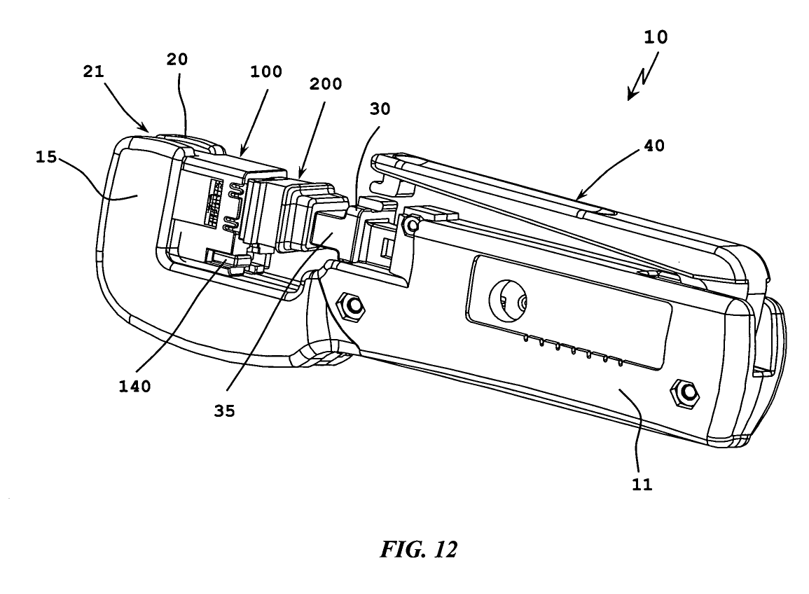

FIG. 12 is a perspective view illustrating the modular jack of FIG. 7 together with the cable manager of FIGS. 2-6 loaded into the tool of FIG. 9.

### DETAILED DESCRIPTION OF EMBODIMENTS

Referring initially to FIG. 1, a cable terminating tool is shown and is generally designated as 10. Reference may be made to U.S. patent application Ser. No. 10/454,709, filed on Jun. 4, 2003, entitled “Cable Terminating Apparatus and Method”, the entire content of which is incorporated herein by reference, for a detailed discussion of the structure and operation of cable terminating tool 10.

As seen in FIG. 1, cable terminating tool 10 generally includes a body 11 having a pair of legs or housings 15 and 20 extending from a front or distal end thereof and defines a cable slot 21 therebetween. Cable slot 21 defines a pass through for a cable and is configured and dimensioned to selectively receive cable bosses 136a, 136b (see FIGS. 2, 3, 5, 6, 8 and 12-14) of a cable manager therein, as will be further described below.

Cable terminating tool 10 further includes an actuation member 30 having a pusher 35 disposed at a front or distal end thereof, and a handle 40 pivotably supported on body 11. Handle 40 is operatively connected to pusher 35 in such a manner that when handle 40 is squeezed or approximated toward body 11, pusher 35 is advanced in a distal direction toward legs 15 and 20. A stripping recess 16 may be provided in body 11 for stripping wire and the like.

Turning now to FIGS. 2-6, embodiments of the presently disclosed cable manager will now be described in detail with reference to the drawing figures wherein like reference numerals identify similar or identical elements. As used herein and as is traditional, the term “distal” refers to that portion which is furthest from the user while the term “proximal” refers to that portion which is closest to the user. In addition, terms such as “above”, “below”, “forward”, “rearward”, etc. refer to the orientation of the figures or the direction of components and are simply used for convenience of description.

As seen in FIGS. 2-6, a cable manager, in accordance with an embodiment of the present disclosure, is generally designated as 100, and is generally configured and dimensioned for cooperation with modular jacks and the like. Additionally, cable manager 100 may be configured and dimensioned for selective mounting on and may provide cable management to both a patching side and a distribution side of a network rack or any other known or subsequently developed racks. Cable manager 100 is preferably formed by an injection molding process or the like (e.g., casting, machining, or any other method known by one having ordinary skill in the art).

Cable manager 100 includes a housing or body 102 including a top wall portion 104, a bottom wall portion 106, a pair of side wall portions 108, 110, and a rear wall portion 112. Housing 102 includes an open front defining a jack receptacle 114 configured and adapted to selectively receive and mate with legs 244 of a modular jack 200. Housing 102 is preferably, but not necessarily, fabricated from a dielectric material or the like.

Jack receptacle 114 of housing 102 includes a first or right side portion 116, a second or middle portion 118, and a third or left side portion 120. Each portion 116, 118 and 120 of receptacle 114 is separated from one another by a dividing wall 122a, 122b. Desirably, each of first or right side portion 116 and third or left side portion 120 are divided into a number of compartments 124a-124e, and 126a-126e , respectively. As will be described in greater detail below, compartments 124a-124e and 126a-126e are configured and dimensioned to receive complementary legs 244 of modular jack 200 therein.

Each of side wall portions 108 and 110, and dividing walls 122a, 122b, includes a series of slots 128 formed along a front edge thereof. Desirably, each of side wall portions 108 and 110, and dividing walls 122a, 122b, includes four slots 128a-128d formed in a front edge thereof. Desirably, slots 128a-128b of side wall portions 108 and 110, and dividing walls 122a, 122b, are in respective aligned registration with one another. In use, as will be described in greater detail below, individual wires “W” from a cable “C” (see FIG. 8) are placed within slots 128a-128d.

As best seen in FIG. 2, slots 128a, 128b of first dividing wall 122a define a first protrusion or the like 129a therebetween, meanwhile slots 128c, 128d of first dividing wall 122b define a second protrusion of the like 129b therebetween. Likewise, slots 128a, 128b of second dividing wall 122b define a first protrusion or the like 129a therebetween, meanwhile slots 128c, 128d of second dividing wall 122b define a second protrusion of the like 129b therebetween. In use, protrusions 129a, 129b of each dividing wall 122a, 122b facilitates separation and placement of the individual wires into their respective slots 128a-128d.

Housing 102 defines a recess 130 formed in bottom wall 106, preferably formed near and in a front edge thereof. Recess 130 is aligned with second or middle portion 118 of receptacle 114. In this manner, in use, a cable “C” or the like may be seated within recess 130 and extend into second or middle portion 118 of receptacle 114. Housing 102 further includes a second bottom wall 106a, parallel to bottom wall 106 and spaced a distance therefrom thereby defining a channel 132 therebetween. Second bottom wall 106a includes a recess 130a formed therein, preferably formed near and in a front edge thereof, which is aligned with second or middle portion 118 of receptacle 114 and recess 130 of bottom wall 106.

As seen in FIGS. 2-6, housing 102 further includes a pair of spaced apart cable bosses 136a, 136b extending from rear wall 112 thereof. Bosses 136a, 136b are configured and dimensioned for selective insertion and/or engagement into slot 21 between legs 15 and 20 of tool 10, as will be described in greater detail below. Inter-engagement of bosses 136a, 136b into slot 21 helps to hold and/or secure cable manager 100 in the tool 10. Other methods of holding and/or securing cable manager 100 in tool 10 include and are not limited to holding with one's hand, using a clamp, tie or the like to hold cable manger 100 against tool 10. Bosses 136a, 136b are desirably in registration with second or middle portion 118 of housing 102. Boss 136a desirably includes a slot 138a (see FIG. 5) which is in registration with channel 132 of housing 102.

Cable manager 100 further includes a cable clamp 140 slidably disposed within channel 132 of housing 102. Cable clamp 140 includes a body portion 142, an enlarged head portion 144 provided at on end of body portion 142, and a hook portion 146 provided at an opposite end of body portion 142. Body portion 142 of cable clamp 140 includes an aperture 142a (see FIG. 3) formed for receiving a pin 149 therein. Pin 149 extends through slots 149a formed in bottom walls 106 and 106a of housing 102 in order to retain cable clamp 140 within channel 132. Slots 149 define the range of motion of cable clamp 140.

Cable clamp 140 has a first position for holding and/or securing a cable “C” (see FIG. 8) in place within recess 130 and 130a of housing 102, and a second position allowing and/or enabling insertion and/or removal of a cable “C” into/from recesses 130, 130a of housing 102. When cable clamp 140 is in the first position, hook portion 146 is in registration with recesses 130, 130a of housing 102. When cable clamp 140 is in the second position, hook portion 146 is out of registration with recesses 130, 130a of housing 102. Accordingly, in use, when cable clamp 140 is in the second position, recesses 130, 130a of housing 102 are open and/or unobstructed to receive cable “C” therein, and following positioning and/or placement of cable “C” into recesses 130, 130a of housing 102, as seen in FIG. 8, cable clamp 140 is returned to the first position wherein hook portion 146 thereof forces cable “C” against an edge of recesses 130, 130a of housing 102.

As seen in FIGS. 3 and 5, cable clamp 140 includes a tail 148 integrally formed with and extending from body portion 142. When cable clamp 140 is seated within channel 132 of housing 102, tail 148 extends to and is received in slot 138a (see FIG. 5) of boss 136a. An end of tail 148, opposite body portion 142, includes a tab 148a configured and adapted to selectively engage a complementary recess 20a (see FIGS. 9 and 10) formed in an inner surface of leg 20 of tool 10. In this manner, cable manager 100 may snap-fit engage tool 10. In order to disengage tab 148a from recess 20a and thus disengage cable manager from tool 10, cable clamp 140 is pressed in the direction of arrow “A” (see FIG. 4), as described above, in order to free tab 148a from recess 20a of leg 20.

As seen in FIG. 3, clamp manager 100 may include a biasing member 150 disposed between cable clamp 140 and left side wall 108 of housing 102. Biasing member 150 tends to maintain clamp member 140 in the first position. In use, upon pressing on head portion 144 of clamp member 140, in the direction of arrow “A” of FIG. 4, clamp member 140 is moved from the first position to the second position, and biasing member 150 is compressed such that when clamp member 140 is released, biasing member 150 returns clamp member 140 to the first position. Desirably, biasing member 150 is a compression spring or the like. This provides a way for the cable manager to hold the cable so that the operator does not need to hold the cable in the cable manage.

Cable manager 100 further includes at least one, preferably a pair of cut-off blades 152a, 152b supported within jack receptacle 114. A first cut-off blade 152a may be disposed within first or right side portion 116 of jack receptacle 114, and a second cut-off blade 152b may be disposed within third or left side portion 120 of jack receptacle 114. Cut-off blades 152a, 152b function to slice through the electrical wires “W” or the like placed within slots 128a-128d when cable “C” is being terminated. Desirably, a front edge of cut-off blades 152a, 152b extend into the regions of slots 128a-128d in order to effectuate the cutting of wires “W”.

Cable manager 100 is configured and dimensioned to operatively engage a modular jack 200 or the like. In particular, cable manager 100 is configured and dimensioned to operatively engage a modular jack, as shown in FIG. 7, in order to lace and or terminate wires “W” to modular jack 200. As seen in FIG. 7, modular jack 200 includes a dielectric housing or body 212 and a plurality of resilient contact tines 214 in parallel arrangement within an interior receptacle 216 of body 212. Body 212 is typically formed of plastic, and the tines 214 are typically formed of a conventional phosphor bronze metal used for modular jacks and other style jacks. Receptacle 216 of jack 200 is sized and configured to receive a plug of conventional design (not shown).

In order to terminate a cable “C” or the like which has been laced to cable manager 100, as seen in FIG. 8, legs 244, projecting from terminal block 243 of modular jack 200, are aligned with and inserted into first or right side portion 116 and third or left side portion 120 of cable manager 100. Once so aligned, cable manager 100 and modular jack 200 are approximated toward one another to complete the termination of cable “C”. Upon termination, cut-off blades 152a, 152b sever the excess length of the wires “W” positioned in slots 128a-128d and the wires “W” electrically connect to the insulation displacement contacts of modular jack 200.

With reference to FIGS. 2-12, a method of terminating a modular jack 200 with a cable manager 100, to an un-terminated cable, is provided. Initially, the outer jacket of an un-terminated cable “C” is stripped away or removed in order to reveal and/or expose the internal twisted pairs of wires “W”. With the twisted pairs of wires “W” exposed, cable “C” is inserted into cable manager 100 by moving cable clamp 140 from the first position to the second position to open recesses 130, 130a of housing 102 and placing cable “C” within recesses 130, 130a of housing 102 and wires “W” within second or middle portion 118 of receptacle 114 of housing 102. Cable clamp 140 is then released such that cable “C” is secured to cable manager 100 between the edges of recesses 130, 130a of housing 102 and hook portion 146 of clamp member 140.

With cable “C” secured to cable manager 100, as seen in FIG. 8, wires “W” are laced through and/or to slots 128a-128d of housing 102. In particular, with wires “W” positioned within second or middle portion 118 of receptacle 114, each wire of each wire pair is laid into and across respective slots 128a-128d. As seen in FIG. 8, two pairs of wires “W” are laid within slots 128a-128d so as to extend beyond right side wall portion 104 of housing 102, and two pairs of wires “W” are laid within slots 128a-128d so as to extend beyond left side wall portion 106 of housing 102.

As seen in FIGS. 10 and 11, with wires “W” laced into cable manager 100, as shown in FIG. 8, cable manager 100 is positioned on legs 15, 20 of tool 10 such that cable “C” extends through slot 21 of tool 10. Additionally, cable manager 100 is oriented such that cable bosses 136a, 136b are directed distally and such that jack receptacle 114 is directed proximally (i.e., facing pusher 35 of tool 10). Cable manager 100 is preferably positioned such that tab 148a of cable clamp 140 snap-fit engages recess 20a of leg 20 of tool 10, as described above.

With cable manager 100 secured onto legs 15, 20 of tool 10, as seen in FIG. 12, modular jack 200 is positioned on legs 15, 20 of tool 10, between cable manager 100 and pusher 35. Preferably legs 244 of modular jack 200 are oriented towards and in registration with jack receptacle 114 of cable manager, as described above. With modular jack 200 so positioned, handle 40 is squeezed, as described above, thereby driving pusher 35 to approximate modular jack 200 toward cable manager 100 and to terminate individual wires “W” of cable “C” (not shown).

Following termination of wires “W” and cable “C”, the assembled cable manager 100 and modular jack 200, are removed from tool 10. The cut ends of wires “W” are removed from the assemble cable manager 100 and modular jack 200. Desirably, a strain relief boot or the like (not shown) may be positioned on cable “C” prior to termination of wires “W”.

It is to be understood that the foregoing description s merely a disclosure of particular embodiments and is no way intended to limit the scope of the invention. Other possible modifications will be apparent to those skilled in the art and all modifications are to be defined by the following claims.

What is claimed is:

1. A cable manager for terminating a cable including a plurality of wires to a modular jack or the like, comprises:
a housing configured and dimensioned to operatively engage the modular jack; and
a cable clamp slideably disposed within the housing in a first and second position for securing the cable to the housing, whereby the twist of the wires is maintained up to the point of termination.

2. The cable manager according to claim 1, wherein the housing includes:
a top wall, a bottom wall, and side walls;
a receptacle defined by the top, bottom and side walls, the receptacle being configured and dimensioned to receive the modular jack therein, the receptacle including a first receptacle portion, a second receptacle portion and a third receptacle portion;
a pair of dividing walls separating the first, second and third receptacle portions;
a plurality of slots formed in a front edge of each of the side walls and the pair of dividing walls; wherein respective slots of the side walls and the pair of dividing walls are aligned with one another; and
cut-off blades positioned in each of the first and third receptacle portions for severing excess wires extending thereacross during a termination procedure.

3. The cable manager according to claim 2, wherein the dividing walls define a plurality of slots formed in a front edge thereof for receiving wires therein, and wherein adjacent pairs of said slots define protrusions therebetween.

4. The cable manager according to claim 2, wherein the bottom wall of the housing defines a recess formed in a front edge thereof, wherein the recess is substantially aligned with the second receptacle portion.

5. The cable manager according to claim 2, wherein the housing includes an outer bottom wall spaced a distance from the bottom wall and defining a channel therebetween, wherein the cable clamp is slideably disposed within the channel.

6. The cable manager according to claim 5, wherein the outer bottom wall includes a recess formed in a front edge thereof, wherein the recess of the outer bottom wall is substantially aligned with the recess of the bottom wall of the housing.

7. The cable manager according to claim 6, wherein the cable clamp includes a hook portion for engaging a cable placed within the recesses of the bottom wall and the outer bottom wall of the housing.

8. The cable manager according to claim 7, wherein the cable clamp has a first position in which the hook portion thereof is in registration with the recesses of the bottom wall and the outer bottom wall of the housing, for securing the cable in position relative to the housing, and a second position in which the hook portion thereof is out of registration with the recesses of the bottom wall and the outer bottom wall of the housing, allowing for the cable to be positioned in said recesses of the housing.

9. The cable manager according to claim 1, wherein the cable clamp is biased to the first position.

10. The cable manager according to claim 1, wherein the cable clamp includes a tail having a tab extending therefrom, wherein the tab is configured and adapted to selectively engage a recess provided on a termination tool.

11. In an improved cable manager for use with a tool for terminating the wires of a cable to a modular jack, wherein the cable manager includes a housing configured and dimensioned to operatively engage the modular jack and wherein the tool includes at least one leg for supporting the cable manager and the modular jack and which is configured and adapted to join the cable manager to the modular jack to terminate the cable, wherein the improvement in the cable manager comprises:
a cable clamp slideably disposed within the housing for securing the cable to the housing, whereby the twist of the wires is maintained up to the point of termination.

12. The cable manager according to claim 11, wherein the housing of the cable manager includes:
a receptacle defined by top, bottom and side walls, the receptacle including a first receptacle portion configured and dimensioned to receive a first set of legs therein, a second receptacle portion configured and dimensioned to receive the wires of the cable therein, and a third receptacle portion configured and dimensioned to receive a second set of legs therein;
a pair of dividing walls separating the first, second and third receptacle portions;
a plurality of slots formed in a front edge of each of the side walls and the pair of dividing walls; wherein respective slots of the side walls and dividing walls are aligned with one another; and
cut-off blades positioned in each of the first and third receptacle portions.

13. The cable manager according to claim 11, wherein a bottom wall of the cable manager housing defines a recess formed in a front edge thereof, wherein the recess is substantially aligned with the second receptacle portion.

14. The cable manager according to claim 13, wherein the housing includes an outer bottom wall spaced a distance from the bottom wall and defining a channel therebetween, wherein the cable clamp is slidably supported within the channel.

15. The cable manager according to claim 14, wherein the outer bottom wall includes a recess formed in a front edge thereof, wherein the recess of the outer bottom wall is substantially aligned with the recess of the bottom wall of the housing.

16. The cable manager according to claim 15, wherein the cable clamp includes a hook portion for engaging a cable placed within the recesses of the bottom wall and the outer bottom wall of the housing.

17. The cable manager according to claim 16, wherein the cable clamp has a first position in which the hook portion thereof is in registration with the recesses of the side wall and the outer side wall of the housing, for securing the cable in position relative to the housing, and a second position in which the hook portion thereof is out or registration with the recesses of the side wall and the outer side wall of the housing, allowing for the cable to be positioned in said recesses of the housing.

18. The cable manager according to claim 17, wherein the cable clamp is biased to the first position.

19. A method of terminating a cable with a modular jack using a cable manager, method comprising the steps of:
providing a cable manager including a housing configured and dimensioned to operatively engage a modular jack, and a cable clamp reciprocally supported by the housing for selectively securing the cable to the housing;
providing a tool for terminating the cable to the modular jack;
moving the cable clamp to an open position such that an end of the cable may be positioned in the housing of the cable manager;
moving the cable clamp to a closed positioned such that the end of the cable is secured to the cable manager;
lacing wires extending from the end of the cable to the housing;
positioning the cable manager into operative association with the terminating tool;
positioning a modular jack into operative association with the terminating tool and the cable manger; and
operating the terminating tool to approximate the cable manager and the modular jack to terminate the cable.

20. The method according to claim 19, wherein the cable clamp includes a tab extending from a surface thereof for selective engagement with a recess formed in a surface of the terminating tool, wherein the method further includes the step of selectively snap-fit engaging the tab of the cable clamp into the recess of the terminating tool.
